(19) United States
(12) Patent Application Publication
(10) Pub. No.: US 2010/0322472 A1
(43) Pub. Date: Dec. 23, 2010

(54) OBJECT TRACKING IN COMPUTER VISION

(75) Inventor: Perttu Hamalainen, Helsinki (FI)

Correspondence Address: Muncy, Geissler, Olds & Lowe, PLLC, 4000 Legato Road, Suite 310, FAIRFAX, VA, 22033, US

(73) Assignee: VIRTUAL AIR GUITAR COMPANY OY, Espoo (FI)

(21) Appl. No.: 12/446,408

(22) PCT Filed: Oct. 16, 2007
(86) PCT No.: PCT/FI07/50556

§ 371 Date: Jul. 15, 2009

(30) Foreign Application Priority Data
Oct. 20, 2006 (FI) 20060926

(51) Int. Cl. G06T 7/00

(52) U.S. Cl. 382/103

(57) ABSTRACT

A method and system for object tracking in computer vision. The tracked object is recognized from an image that has been acquired with the camera of the computer vision system. The image is processed by randomly generating samples in the search space and then computing fitness functions. Regions of high fitness attract more samples. The random selection may be based on standard deviation or other weights. Computations are stored into a tree structure. The tree structure can be used as prior information for next image.

### FIELD OF THE INVENTION

This invention is related to model-based computer vision. The invention relates particularly to finding a combination of model parameters so that the model matches a visual observation.

### BACKGROUND OF THE INVENTION

Computer vision has been used in several different application fields. Different applications require different approaches as the problem varies according to the applications. For example, in quality control a computer vision system uses digital imaging for obtaining an image to be analyzed. The analysis may be, for example, a color analysis for paint or the number of knot holes in plank wood.

One possible application of computer vision is model-based vision wherein a target, such as a face, needs to be detected in an image. It is possible to use special targets, such as a special suit for gaming, in order to facilitate easier recognition. However, in some applications it is necessary to recognize natural features from the face or other body parts. Similarly it is possible to recognize other objects based on the shape or form of the object to be recognized. Recognition data can be used for several purposes, for example, for determining the movement of an object or for identifying the object.

The problem in such model-based vision is that it is computationally very difficult. The observations can be in different positions. Furthermore, in the real world the observations may be rotated around any axis. Thus, a simple model and observation comparison is not suitable as it does not take rotations and inclinations into account.

Previously this problem has been solved by optimization and Bayesian estimation methods, such as genetic algorithms and particle filters. Drawbacks of the prior art are that the methods require too much computing power for many real-time applications and that finding the optimum model parameters is uncertain.

### SUMMARY

The invention discloses a computer vision method, system and computer program product for tracking an object. The method is initialized by determining an object to be tracked. The object may be a specific special purpose object to be tracked or any suitable image or form, such as a face. Then an image including the determined object is acquired. Typically a regular digital camera or video camera is used for acquiring the image.

The object is represented by a model, the state of which is specified by a parameter vector. For example, the model can be an image of a planar object that needs to be found. In this case, the parameter vector has six elements: three-dimensional translation and rotation. The value of the parameter vector, that is, a point in the parameter search space, defines the appearance of the model in the image space. The goal of the tracking is to find the parameter vector for which the appearance of the model corresponds to the acquired image.

The correct parameter vector is found by generating random parameter vector samples so that first, a portion of the search space is selected. Then a probability distribution is formulated based on the selected portion of the search space. Then a sample is generated from the formulated probability distribution. For the generated sample it is possible to compute a fitness function. Based on the generated sample, a portion of the search space is selected. The selected portion is then divided. These steps are repeated until a termination condition has been fulfilled. The termination condition may be a quality threshold, the number of passes, a time interval or similar. Thus, the selection and computing is a continuous process wherein the previous data is used for further computations.

In an embodiment of the invention the computed data is stored into a tree structure, which is preferably a kd-tree. The tree is build for each acquired frame. In a further embodiment the tree is build based on the previous tree. Thus, the information of the previous tree may be used and the number of passes needed for acceptable recognition is reduced significantly.

The benefit of the invention is that it is capable of recognizing moving objects. Thus, it is suitable for a plurality of applications that need to track a desired object. The solution according to the present invention is able to recognize the object in fewer passes than the prior art solutions. Thus, the recognition can be made more accurate or it can be performed in fewer passes or at shorter time intervals. This reduces the required computing resources in order to provide the desired result. Furthermore, the invention solves the problems of prior art more robustly and with less computing power.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a block diagram of an example embodiment of the present invention

FIG. 2 is a flow chart of the method disclosed by the invention

FIG. 3 is a block diagram of an example implementation of the method presented in FIG. 2.

FIG. 4 is a graphical representation of the result of an example implementation of the invention.

### DETAILED DESCRIPTION OF THE INVENTION

Reference will now be made in detail to the embodiments of the present invention, examples of which are illustrated in the accompanying drawings.

This document uses the following mathematical notation
x vector of real values
x^{T} vector x transposed
x⁽ⁿ⁾ the nth element of x
A matrix of real values
a^{(n,k)} element of A at row n and column k
[a,b,c] a vector with the elements a, b, c
f(x) fitness function
E[x] expectation (mean) of the random variable x
std[x] standard deviation of the random variable x

According to the present invention the solution vector x containing k model parameters is found through importance sampling, treating the fitness function f(x) as a probability density function of the k parameters. Samples (random parameter vector values) are generated from an estimate of the fitness probability distribution. The possible values for the k parameters constitute a k-dimensional search space. Most of the samples are generated at regions of the search space where fitness is high. In an embodiment of the invention, the importance sampling uses a kd-tree to adaptively divide the search space into smaller and smaller k-dimensional hypercubes.

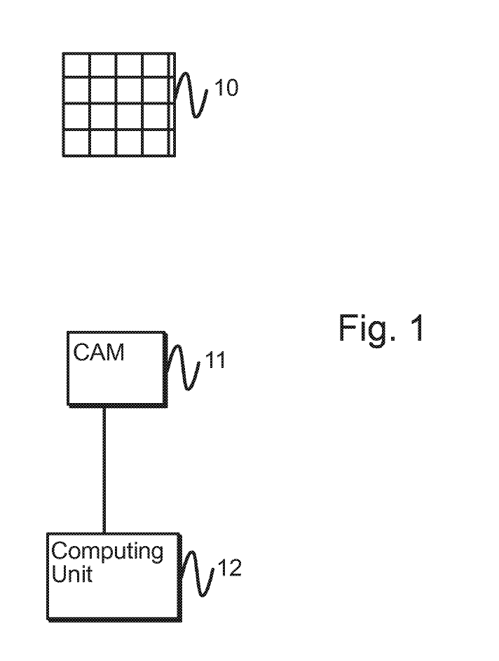

In FIG. 1, a block diagram of an example embodiment according to the present invention is disclosed. The example embodiment comprises a model or a target 10, an imaging tool 11 and a computing unit 12. The target 10 is in this application a checker board. However, the target may be any other desired target that is particularly made for the purpose or a natural target, such as a face. The imaging tool may be, for example, an ordinary digital camera that is capable of providing images at desired resolution and rate. The computing unit 12 may be, for example, an ordinary computer having enough computing power to provide the result at the desired quality. Furthermore, the computing device includes common means, such as a processor and memory, in order to execute a computer program or a computer implemented method according to the present invention. Furthermore, the computing device includes storage capacity for storing target references.

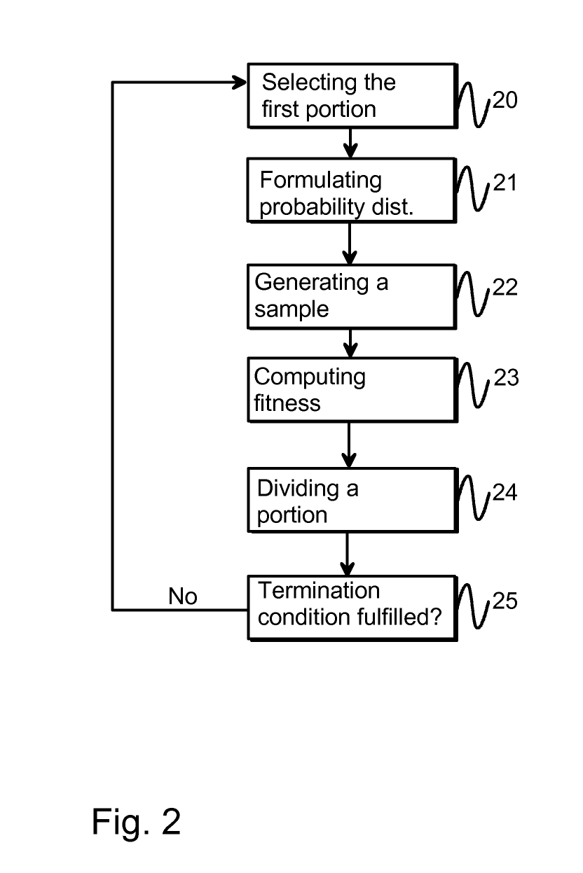

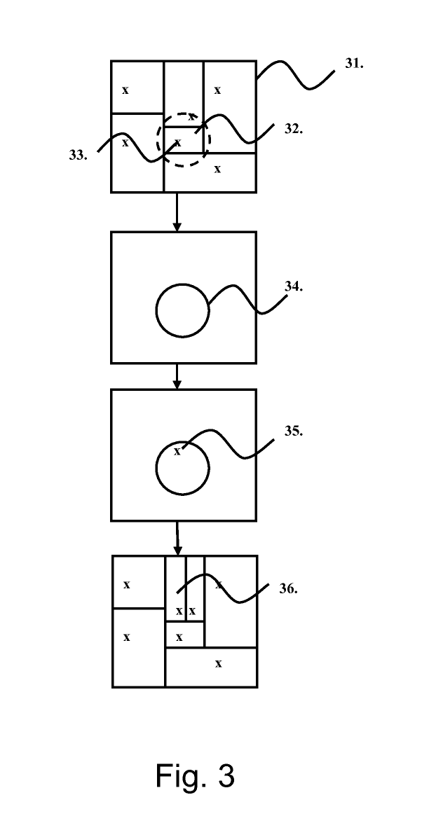

FIG. 2 discloses a flow chart of an example method according to present invention. In order to provide better understanding of the present invention FIG. 3, which is a graphical presentation of an example implementation of the method of FIG. 2, is referred to in the following explanation of the method of FIG. 2. FIGS. 2 and 3 disclose a basic setting for recognizing the target from an image that has been acquired with the imaging device.

For simplicity of explanation, the search space 31 in FIG. 3 is a two-dimensional projection of the general k-dimensional search space divided into k-dimensional hypercubes. Thus, the hypercubes are depicted as rectangles. The method according to the example embodiment of the present invention is initiated by selecting a portion 32 of the search space, step 20. At first, when the search space is not populated with samples, the selected portion 32 may equal the whole search space. FIG. 3 shows the proceeding of the method after a number of initial iterations so that there already are six samples in the search space 31, marked with letter x, including the sample 33 inside the selected portion 32. The probability of a portion to be selected is a function of the fitness of the samples inside the portion and the size of the portion.

After selecting the portion of the search space, a probability distribution 34 is formulated based on the portion, step 21. In FIG. 3, the probability distribution 34 is depicted so that sample probability is nonzero inside the elliptic contour. The probability distribution 34 is typically formulated so that sample probability is high inside and in the vicinity of the selected portion 32.

A sample 35 is then generated from the formulated distribution, step 22, and its fitness is computed, step 23. The fitness computation is application specific. There are several different functions that can be used in the fitness computations. The purpose of the fitness function is to find out how well the model parameters given by the sample 35 correspond to the appearance and location of the tracked target.

An example of an appropriate fitness function is normalized cross-correlation. For example, a checkerboard is an example of a planar object with a texture that can be recognized. In this case, normalized cross-correlation can be used as the fitness function. A further example of an appropriate fitness function is the sum of edge intensity along a contour. Objects are often modelled and tracked using contour templates. In this case, fitness can be formulated as the sum of the magnitude of image gradient at a number of contour points, evaluated in the direction of the normals of the contour. These two fitness functions are just examples and a person skilled in the art may choose a different fitness function that is suitable for the object to be tracked.

After the fitness computation, a new portion 36 is generated by dividing the portion of the search space in which the sample 35 lies, step 24.

Steps 20-24 are repeated until a termination condition is fulfilled, step 25.

The termination condition may be a quality threshold, the number of passes, a time interval or similar. For example, it may be determined that 400 samples are generated and that the sample of highest fitness is the best possible result or at least good enough. The termination condition depends on the desired application.

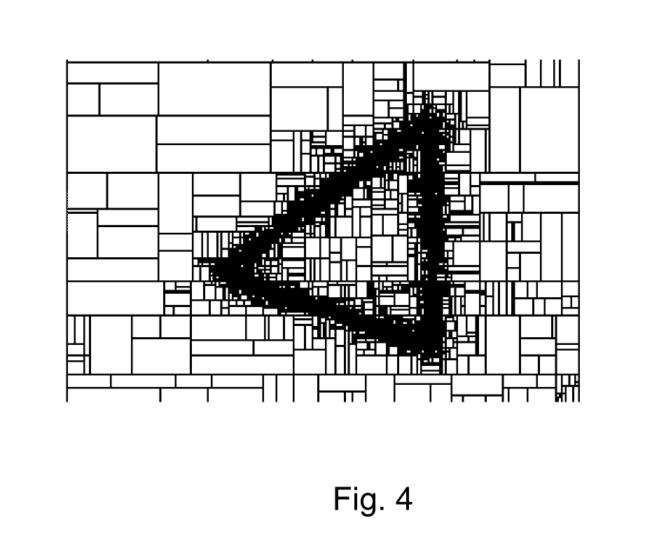

FIG. 4 shows an example portioning of space generated by the invention when the fitness function is zero except along the edges of a triangle.

In the simple embodiment the recognition for the following image is started from a scratch. In a more advanced embodiment, the prior information is used in the following recognitions. For example, if the application follows a moving target, the target will be close to where it was in the previous frame.

The Kd-tree mentioned above is a tree-like data structure where each node has two children. Each node j of the tree stores the following information, or other information from which the following information can be derived:
1. Vectors aⱼ and bⱼ representing the locations of two opposite corners of a k-dimensional hypercube. a⁽ⁿ⁾≦b⁽ⁿ⁾ for all n
2. A sample vector xⱼ, and its fitness f(xⱼ)

An embodiment of the invention could contain an implementation of the following pseudocode, executed for each video frame (captured image):
I. Initialize a kd-tree by creating the root node r for which aᵣ⁽ⁿ⁾ equals the minimum acceptable value for x⁽ⁿ⁾, and bᵣ⁽ⁿ⁾ equals the maximum acceptable value for x⁽ⁿ⁾. Randomize xᵣ⁽ⁿ⁾ uniformly so that aᵣ⁽ⁿ⁾≦xᵣ⁽ⁿ⁾≦bᵣ⁽ⁿ⁾
II. Repeat until an acceptable solution is found{
   1. Randomly select a node i of the kd-tree t₋ from a discrete probability distribution of selection probabilities pᵢ=f(xᵢ)Vᵢ^{g}, where Vᵢ is the volume of the hypercube with corners aᵢ and bᵢ, g is a user defined greediness parameter, and the subscript i denotes the index of a node in the tree t₋
   2. Generate a sample x so that each element x⁽ⁿ⁾ is sampled from a sampling distribution with mean equal to the sample inside the selected kd-tree node, that is, E[x⁽ⁿ⁾]=xᵢ⁽ⁿ⁾. The standard deviation of the sampling distribution is proportional to the width of the hypercube in each dimension, that is, std[x⁽ⁿ⁾]=σ(bᵢ⁽ⁿ⁾−aᵢ⁽ⁿ⁾, where σ is a user-defined relative deviation. For example, σ=1.
   3. Evaluate the fitness f(x), specific to the application
   4. Find a node j in the kd-tree for which aⱼ⁽ⁿ⁾≦x⁽ⁿ⁾≦bⱼ⁽ⁿ⁾ for all n
   5. Add two child nodes k and l to node j. Set aₖ⁽ⁿ⁾=aⱼ⁽ⁿ⁾, bₖ⁽ⁿ⁾=bⱼ⁽ⁿ⁾, aₗ⁽ⁿ⁾=aⱼ⁽ⁿ⁾, bₗ⁽ⁿ⁾=bⱼ⁽ⁿ⁾ for all n except for the splitting dimension s that maximizes |xⱼ^{(s)}−x^{(s)}|. Set bₖ^{(s)}=aₗ^{(s)}=0.5(xⱼ^{(s)}+x^{(s)}). If aₖ^{(s)}≦xⱼ^{(s)}≦bₖ², set xₖ=xⱼ and xₗ=x, otherwise set xₗ=xⱼ and xₖ=x.

The pseudocode above mentions two kd-trees: t₋ and t₊. These can be one and the same tree, but if temporal coherence of the searched solutions is assumed, two separate trees can be used so that t₋ is the of the previous video frame. Temporal coherence can be assumed, e.g., when tracking real-world objects that move with finite velocity and acceleration.

The selecting of a kd-tree node and the subsequent sample generation can be seen as drawing a sample from an approximation of f(x). Storing the new sample and the associated fitness to the tree increases the accuracy of the approximation. At first, the samples are uniform, but then begin to follow the probability density specified by f(x).

In an advanced embodiment of the invention, step II.1. of the pseudocode may be modified so that the mean of the sampling distribution is computed as E[x⁽ⁿ⁾]=xᵢ⁽ⁿ⁾+c⁽ⁿ⁾(xᵢ⁽ⁿ⁾−xᵢ₋⁽ⁿ⁾), where xᵢ₋ is the xᵢ of previous video frame that was used to generate the x, of current video frame. c is a vector that specifies the velocity model assumed. If c⁽ⁿ⁾=0, the sampled parameter n is assumed to be constant. If c⁽ⁿ⁾=1, the sampled parameter n is assumed to be changing with a constant velocity.

The sampling distribution mentioned in the pseudo-code above can be any distribution, e.g., a normal distribution x⁽ⁿ⁾˜N(xᵢ⁽ⁿ⁾, σ²(bᵢ⁽ⁿ⁾−aᵢ⁽ⁿ⁾)²). A normal distribution works well, because the desirable properties of the sampling distribution are that most of the samples will be generated in the vicinity of the mean, but there is a finite probability to generate samples at any part of the search space. This guarantees an important property of the invention: the selected and split portions of search space are not always the same. If samples were only generated inside the hypercube selected at step II.1., a kd-tree node (hypercube) with a sample of zero fitness would never be split, which would increase the risk of not finding the correct solution.

In an embodiment of the invention, a portion of the search space is selected and a sampling distribution is formulated based on the selected portion. The standard deviation of the sampling distribution is proportional to the size of the selected portion. Step 2 of the pseudocode above gives an example of this in the case where the portion is a hypercube. The purpose of the sampling distribution is to spread the samples in the vicinity of the selected portion. Considering the whole optimization process, it is important that samples are spread less as the iteration proceeds and the selected portions decrease in size. The probability density function of the sampling distribution can also be thought as a filtering kernel used to blur the probability density of the samples. The blurring is adaptive so that the kernel size is proportional to the size of the selected portion.

In an embodiment of the invention, step II.1. of the pseudocode can be modified so that the node with maximum p, is selected. This can accelerate convergence in some cases.

The splitting dimension s may also be chosen differently from the pseudocode, e.g., randomly.

It should be noted that in a practical implementation of the pseudocode, the probabilities pᵢ of step II.1. should be normalized so that their sum equals 1.

The present invention may have applications outside the field of computer vision too. In general, the kd-tree gives a piecewise constant approximation of f(x), which can be used to estimate the definite integral of f(x) over a region. If f(x) is a light transport function along path x, the present invention can be used to compute illumination for image rendering. The present invention can also be used for problem solving and optimization, that is, for finding the vector x that maximizes f(x) in any application where f(x) can be computed.

It is obvious to a person skilled in the art that with the advancement of technology, the basic idea of the invention may be implemented in various ways. The invention and its embodiments are thus not limited to the examples described above; instead they may vary within the scope of the claims.

1. A method for tracking an object represented by a model with a number of parameters, the possible parameter combinations constituting a search space, the method comprising:
determining a model of the object to be tracked;
acquiring an image;
selecting a portion of the search space;
formulating a probability distribution based on the selected portion of the search space;
generating a sample from the formulated probability distribution;
computing the fitness function of the generated sample;
selecting a portion of the search space that contains the sample;
dividing the second selected portion of the search space;
repeating the steps above until a termination condition has been fulfilled.

2. The method according to claim 1, wherein the termination condition is a quality parameter, a number of passes or a time interval.

3. The method according to claim 1, wherein selecting the second portion based on a standard deviation extending beyond the periphery of the previous portion.

4. The method according to claim 1, wherein storing computed data into a tree structure.

5. The method according to claim 4, wherein building a new tree for each acquired image based on the tree of the previous image.

6. The method according to claim 4, wherein the tree structure is a kd-tree.

7. The method according to claim 5, wherein choosing the first portion from the tree built for the previous image and the second portion from the tree being built for the current frame.

8. The method according to claim 1, wherein the formulated probability distribution is a normal distribution with mean and standard deviation according to the locations of previous samples generated.

9. The method according to claim 6, wherein the selected portions are hypercubes corresponding to kd-tree nodes.

10. A system for tracking an object, which system comprises:
an object to be tracked;
a camera; and
a computing unit, wherein the system is configured to determine a model of the object to be tracked and acquire an image;
select a portion of the search space;
formulate a probability distribution based on the selected portion of the search space;
generate a sample from the formulated probability distribution;
compute the fitness function of the generated sample;
select a portion of the search space that contains the sample;
divide the second selected portion of the search space;
repeat the steps above until a termination condition has been fulfilled.

11. The system according to claim 10, wherein the termination condition is a quality parameter, a number of passes or a time interval.

12. The system according to claim 10, wherein the system is configured to select the second portion based on a standard deviation extending beyond the periphery of the previous portion.

13. The system according to claim 10, wherein the system is configured to store computed data into a tree structure.

14. The system according to claim 13, wherein the system is configured to build a new tree for each acquired image based on the tree of the previous image.

15. The system according to claim 13, wherein the tree structure is a kd-tree.

16. The system according to claim 14, wherein the system is further configured to choose the first portion from the tree built for the previous image and the second portion from the tree being built for the current frame.

17. The system according to claim 10, wherein the formulated probability distribution is a normal distribution with mean and standard deviation according to the locations of previous samples generated.

18. The system according to claim 15, wherein the selected portions are hypercubes corresponding to kd-tree nodes.

19. A computer program embodied on a computer-readable medium comprising program code means adapted to perform the following steps when the program is executed in a computing device:
determining a model of the object to be tracked;
acquiring an image;
selecting a portion of the search space;
formulating a probability distribution based on the selected portion of the search space;
generating a sample from the formulated probability distribution;
computing the fitness function of the generated sample;
selecting a portion of the search space that contains the sample;
dividing the second selected portion of the search space;
repeating the steps above until a termination condition has been fulfilled.

20. The method according to claim 19, wherein the termination condition is a quality parameter, a number of passes or a time interval.

21. The computer program according to claim 19, wherein the program code means are further adapted to perform selecting the second portion based on a standard deviation extending beyond the periphery of the previous portion.

22. The computer program according to claim 19, wherein the program code means are further adapted to perform storing computed data into a tree structure.

23. The computer program according to claim 22, wherein the program code means are further adapted to perform building a new tree for each acquired image based on the tree of the previous image.

24. The method according to claim 22, wherein the tree structure is a kd-tree.

25. The computer program according to claim 22, wherein the program code means are further adapted to perform choosing the first portion from the tree built for the previous image and the second portion from the tree being built for the current frame.

26. The method according to claim 19, wherein the formulated probability distribution is a normal distribution with mean and standard deviation according to the locations of previous samples generated.

27. The method according to claim 24, wherein the selected portions are hypercubes corresponding to a kd-tree node.
